(19) United States
(12) Patent Application Publication
(10) Pub. No.: US 2023/0202021 A1
(43) Pub. Date: Jun. 29, 2023

(54) TELESCOPIC HAND TOOL

(71) Applicant: KING TONY TOOLS CO., LTD., Taichung (TW)

(72) Inventor: Ching-Hua Lai, TAICHUNG (TW)

(21) Appl. No.: 17/689,595

(22) Filed: Mar. 8, 2022

(30) Foreign Application Priority Data
Dec. 29, 2021 (TW) 110149492

(51) Int. Cl. B25G 1/04

(52) U.S. Cl. CPC B25G 1/04

(57) ABSTRACT

A telescopic hand tool has an inner rod and an outer tube slidable relative to the inner rod. The inner rod is formed with at least one rack gear. The outer tube is formed with a positioning hole. A positioning member is provided in the positioning hole. The positioning member has at least one toothed portion. A control sleeve is slidably fitted on the outer tube. The control sleeve selectively presses the positioning member to make the toothed portion engaged with the at least one rack gear, or selectively releases the positioning member to make the inner rod and the outer tube slidable with each other so that the toothed portion is disengaged from the at least one rack gear and selects a desired meshing point with the at least one rack gear in response to the adjustment. Thus, the length of the telescopic hand tool is adjustable in a stepless manner.

### FIELD OF THE INVENTION

The present invention relates to a hand tool, and more particularly to a telescopic hand tool.

### BACKGROUND OF THE INVENTION

Most of the telescopic rods of conventional telescopic hand tools adopt steel balls to position the telescopic rods. Through a plurality of positioning notches between the inner tube and the outer tube of the telescopic rod and a positioning steel ball, the positioning steel ball is selectively engaged in one of the positioning notches to change the relative position between the inner tube and the outer tube, thereby adjusting the length of the telescopic rod.

However, this adjustment is limited by the positioning steel ball with certain diameter, so there will be a certain interval between each two positioning notches. As a result, the telescopic rod is constrained by multi-steps when adjusting the length so that the desired length the user required can't be accurately met. Furthermore, the positioning steel ball is in point contact with the telescopic tube, so the contact area is relatively small. When the telescopic hand tool is impacted by external force, it is likely to lead loosen or slip. Besides, when the user adjusts the length of the telescopic rod, an unexpected relative rotation between the inner tube and the outer tube of the telescopic rod might occur to cause deviation.

### SUMMARY OF THE INVENTION

The primary object of the present invention is to provide a telescopic hand tool which enables to adjust its length in a stepless manner and is not easy to loosen or slip.

A telescopic hand tool comprises a telescopic rod. One end of the telescopic rod is provided with a working head, and another end of the telescopic rod is provided with a grip. The telescopic rod includes an inner rod and an outer tube slidably fitted on the inner rod. A circumferential side wall of the inner rod is formed with at least one rack gear along an axis. A circumferential side wall of the outer tube is formed with a positioning hole corresponding to the rack gear. A positioning member is provided in the positioning hole. The positioning member has a reciprocating movement along a central axis of the positioning hole. The positioning member has at least one toothed portion corresponding to the rack gear. The toothed portion has at least two engaging teeth. A control sleeve is slidably fitted on the outer tube. The control sleeve is slidable along the outer tube to form a locking position and an unlocking position. When in the locking position, the control sleeve presses the positioning member so that the toothed portion is engaged with the rack gear. When in the unlocking position, the control sleeve releases the positioning member so that the toothed portion is disengaged from the rack gear.

In the telescopic hand tool provided by the present invention, when the user adjusts the length of the telescopic rod to allow a relative sliding motion between the inner rod and the outer tube, the toothed portion of the positioning member can be adjusted to mesh with a corresponding meshing point on the rack gear to position the inner rod and the outer tube. Thus, the length of the telescopic rod can be adjusted in a stepless manner Because the toothed portions each have at least two engaging teeth, the contact area and positioning strength between the toothed portions and the two teeth can be improved greatly, so it is not easily affected by external force to avoid loosen or slip.

### BRIEF DESCRIPTION OF THE DRAWINGS

FIG. 1 is a perspective view in accordance with a preferred embodiment of the present invention;

FIG. 2 is an exploded view in accordance with the preferred embodiment of the present invention;

FIG. 3 is a cross-sectional view in accordance with the preferred embodiment of the present invention;

FIG. 4 is a perspective view of the positioning member in accordance with the preferred embodiment of the present invention;

FIG. 5 is a cross-sectional view taken along line 5-5 of FIG. 3;

FIG. 6 is a schematic view of the preferred embodiment of the present invention when in use; and

FIG. 7 is a cross-sectional view taken along line 7-7 of FIG. 3.

### DETAILED DESCRIPTION OF THE PREFERRED EMBODIMENTS

Embodiments of the present invention will now be described, by way of example only, with reference to the accompanying drawings.

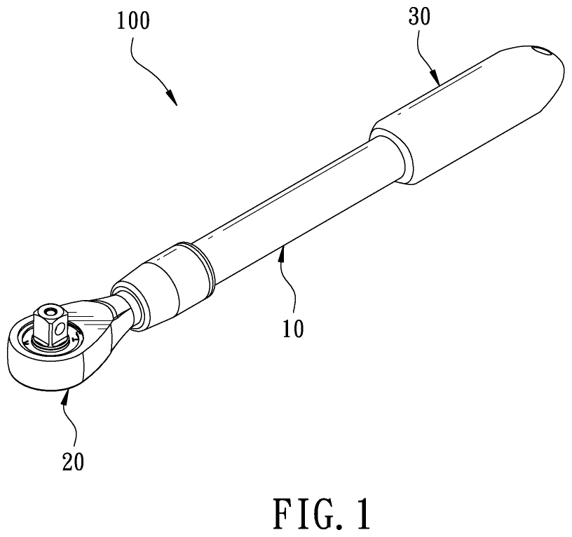

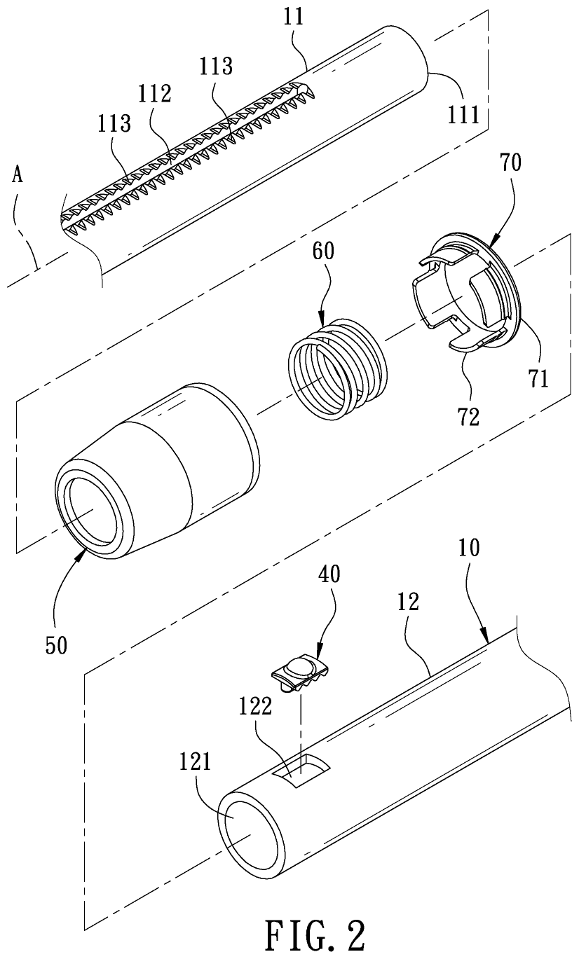

FIG. 1 is a perspective view in accordance with a preferred embodiment of the present invention. FIG. 2 is an exploded view in accordance with the preferred embodiment of the present invention. The present invention disclosures a telescopic hand tool 100. The telescopic hand tool 100 comprises a telescopic rod 10. One end of the telescopic rod 10 is provided with a working head 20, and the other end of the telescopic rod 10 is provided with a grip 30. In this embodiment, the telescopic rod 10 includes an inner rod 11 and an outer tube 12. One end of the inner rod 11 is connected to the working head 20, and the other end of the inner rod 11 forms a free end 111. One end of the outer tube 12 forms an open end 121. The free end 111 of the inner rod 11 is inserted through the open end 121 into the outer tube 12 and can be slid back and forth relative to the outer tube 12. The other end of the outer tube 12 is provided with the grip 30. Thus, the distance between the working head 20 and the grip portion 30 can be adjusted by adjusting the length of the telescopic rod 10. It is worth mentioning that the positions of the working head 20 and the gripping portion 30 can be exchanged, that is, the working head 20 is disposed on the outer tube 12, and the grip portion 30 is disposed on the inner rod 11.

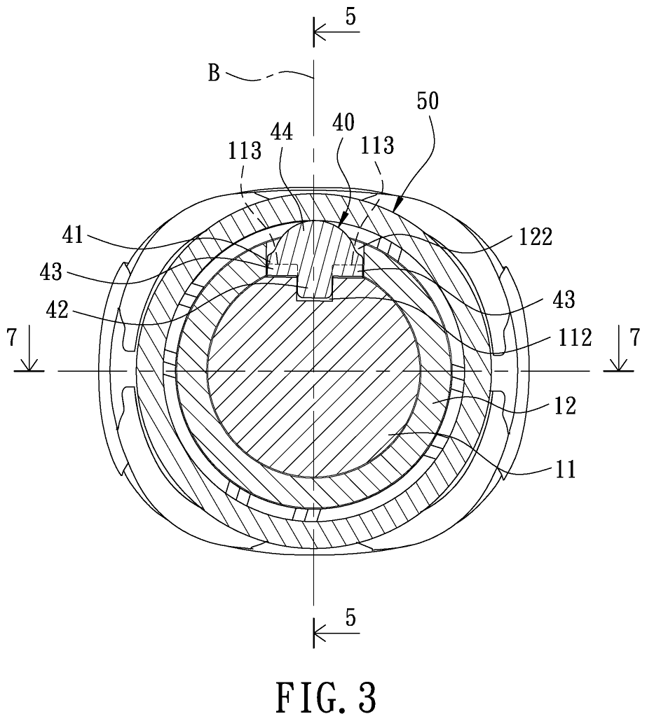

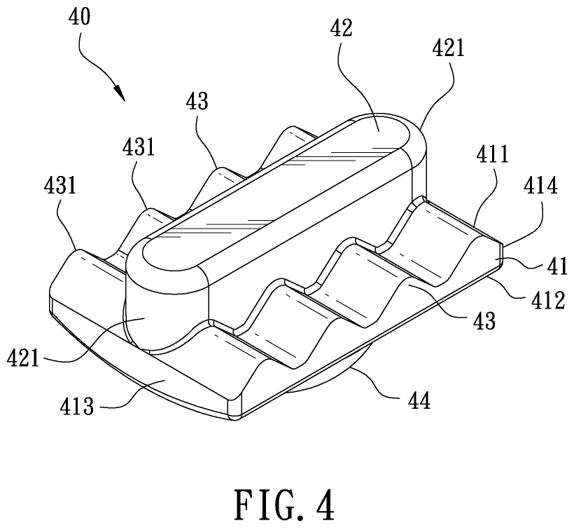

FIG. 3 is a cross-sectional view in accordance with the preferred embodiment of the present invention. FIG. 4 is a perspective view of a positioning member in accordance with the preferred embodiment of the present invention. Referring to FIG. 2, a circumferential side wall of the inner rod 11 is formed with a guide groove 112 extending along an axis A, and two sides of the guide groove 112 are disposed with a rack gear 113 separately. A circumferential side wall of the outer tube 12 is formed with a positioning hole 122 corresponding to the two rack gears 113. The positioning hole 122 is provided with a positioning member 40. The positioning member 40 has a degree of freedom of reciprocating movement along a central axis B of the positioning hole 122. The axial direction of the central axis B is perpendicular to the axis A. The positioning member 40 has a base 41 corresponding in shape to the positioning hole 122. The base 41 has a first side surface 411 facing the inner rod 11 and a second side surface 412 opposite to the first side surface 411. The first side surface 411 is provided with a guide slider 42 corresponding to the guide groove 112. The guide slider 42 is slidable in the guide groove 112. Two ends of the guide slider 42 are formed with arc-shaped surfaces 421, so that the guide slider 42 slides more smoothly in the guide groove 112. Two sides of the guide slider 42 are separately provided with a toothed portion 43 corresponding to the rack gears 113. The toothed portions 43 each have at least two engaging teeth 431 to be engaged with the two rack gears 113. The second side surface 412 is provided with a bearing portion 44. In this embodiment, the number of the rack gears 113 and the toothed portions 43 are not limited thereto. In principle, the circumferential side wall of the inner rod 11 is provided with the at least one rack gear 113, and the positioning member 40 is provided with the at least one toothed portion 43 to achieve the purpose of the present invention.

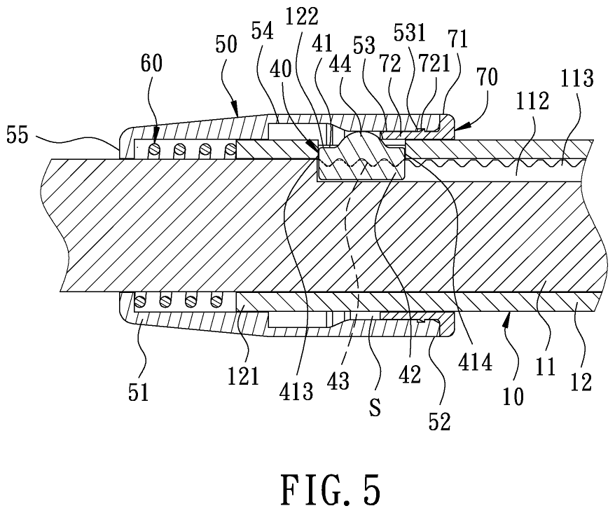

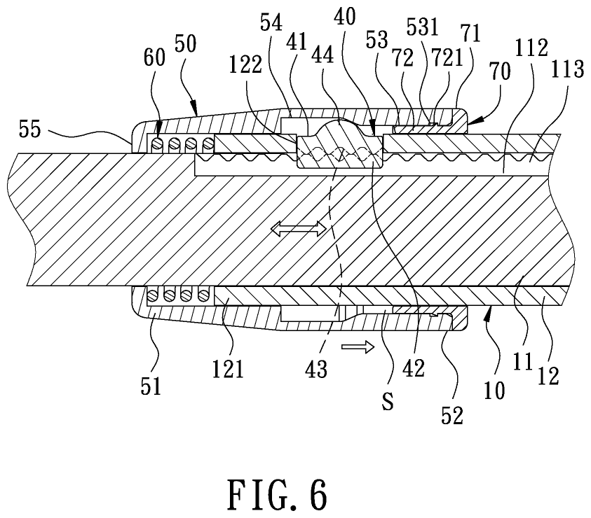

FIG. 5 is a cross-sectional view taken along line 5-5 of FIG. 3. FIG. 6 is a schematic view of the preferred embodiment of the present invention when in use. The telescopic hand tool 100 further includes a control sleeve 50 that is disposed on an outer periphery of the outer tube 12 and surrounds the positioning member 40. The control sleeve 50 has a first end 51 facing the working head 20 and a second end 52 opposite to the first end 51. A reduced portion 53 is defined on an inner wall of the control sleeve 50 adjacent to the second end 52. One side of the reduced portion 53 is adjacently connected to an enlarged portion 54. An inner diameter of the enlarged portion 54 is greater than an inner diameter of the reduced portion 53. The control sleeve 50 is slidable along the outer tube 12 to form a locking position as shown in FIG. 5 and an unlocking position as shown in FIG. 6. When the control sleeve 50 is in the locking position, the bearing portion 44 of the positioning member 40 is restricted by the control sleeve 50 and is pressed against the reduced portion 53, so that the toothed portions 43 are engaged with the rack gears 113. At this time, the inner rod 11 is unable to slide relative to the outer tube 12. When the control sleeve 50 is in the unlocking position, the bearing portion 44 is disengaged from the reduced portion 53 to be in the enlarged portion 54 of the control sleeve 50, so as to release the positioning member 40. Therefore, the positioning member 40 regains the degree of freedom of reciprocating movement along the central axis B of the positioning hole 122, so that the toothed portions 43 are disengaged from the rack gears 113. At this time, the inner rod 11 is able to slide relative to the outer tube 12.

When the user intends to adjust the length of the telescopic hand tool 100, the user merely pushes the control sleeve 50 to move from the locking position to the unlocking position and then pulls the inner rod 11 to adjust the relative position between the inner rod 11 and the outer tube 12. At this time, the positioning member 40 regains the degree of freedom of reciprocating movement along the central axis B of the positioning hole 122, the toothed portions 43 are disengaged from the rack gears 113 in response to the adjustment of the telescopic rod 10, and then the toothed portion 43 enables to select a corresponding meshing point with the rack gears 113. After that, the user pushes the control sleeve 50 back to the locking position, so that the toothed portions 43 are engaged with the rack gears 113, and the inner rod 11 and the outer tube 12 are positioned. In this way, the length of the telescopic rod 10 can be adjusted in a stepless manner Because the toothed portions 43 each have at least two engaging teeth 431, the contact area and positioning strength between the toothed portions 43 and the rack gears 113 can be improved greatly, so it is not easily affected by external force to avoid loosen or slip. On the other hand, when the user adjusts the relative position between the inner rod 11 and the outer tube 12, the guide slider 42 slides along the guide groove 112 to ensure that there is no relative rotation between the inner rod 11 and the outer tube 12.

Referring to FIG. 5, one side of the base 41, facing the working head 20, has a first restricting edge 413, and the other side of the base 41, facing the grip 30, has a second restricting edge 414. When the control sleeve 50 is either in the locking position or in the unlocking position, the first restricting edge 413 and the second restricting edge 414 are continuously restricted by an inner peripheral wall of the positioning hole 122, so that the bearing portion 44 of the positioning member 40 continuously faces the inner wall of the control sleeve 50, and the toothed portions 43 continuously face the rack gears 113. Failure for actuation due to incorrect alignment between the control sleeve 50, the bearing portion 44 and the toothed portion 43 is avoidable.

When the telescopic hand tool 100 is to be assembled, the assembly technician may attach the positioning member 40 onto the inner rod 11. At this time, because the toothed portions 43 are engaged with the rack gears 113 to form a teeth engagement after assembly, thus the positioning member 40 is not likely to drop. Compared with the conventional steel ball structure, the telescopic hand tool 100 provided by the present invention has a better positioning effect for assembly. The guide slider 42 of the positioning member 40 is located in the guide groove 112 when assembled, which prevents the positioning member 40 from dropping.

Referring to FIG. 5 and FIG. 6, the first end 51 of the control sleeve 50 extends beyond the open end 121 of the outer tube 12 and has a stop portion 55. An elastic member 60 fitted on the inner rod 11 is provided between the stop portion 55 and the open end 121 of the outer tube 12. The elastic member 60 provides an elastic force to push the control sleeve 50, so that the control sleeve 50 has a tendency to move toward the locking position. Thus, after adjusting the length of the telescopic rod 10, as long as the control sleeve 50 is released by the user, the control sleeve 50 is pushed back to the locking position by the elastic member 60. It is convenient for operation. On the other hand, the inner diameter of the reduced portion 53 is greater than the outer diameter of the outer tube 12, so that an annular space S is formed between the reduced portion 53 and the outer tube 12. The telescopic hand tool 100 further includes a restricting ring 70. The restricting ring 70 has a ring wall 71 located at the second end 52. The restricting ring 70 has at least one blocking wall 72 corresponding to the annular space S. The blocking wall 72 is inserted in the annular space S. In this embodiment, the reduced portion 53 has a mating groove 531. The blocking wall 72 has a mating block 721 corresponding to the mating groove 531. The mating block 721 is mated with the mating groove 531, so as to secure the restricting ring 70 to the second end 52 of the control sleeve 50. Thereby, the blocking wall 72 blocks the protrusion 44 of the positioning member 40 to prevent the control sleeve 50 from slipping off the outer tube 12.

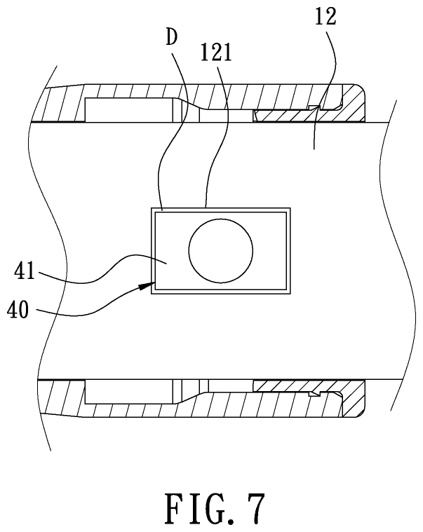

FIG. 7 is a cross-sectional view taken along line 7-7 of FIG. 3. The base 41 is slightly smaller than the positioning hole 122, so that a gap D is defined between the base 41 and the inner peripheral wall of the positioning hole 122. The positioning member 40 further has a degree of freedom of translational movement relative to the outer tube 12. When the user adjusts the relative position between the inner rod 11 and the outer tube 12 for the positioning member 40 to bounce in the positioning hole 122 to select a desired meshing point, a certain tolerance can be kept to ensure that the toothed portions 43 of the positioning member 40 to be engaged with the teeth 113. It is worth mentioning that the inner rod 11 is a round rod, and the second side surface 412 forms an arc surface corresponding to the surface of the inner rod 11, so that the positioning member 40 is close to the curvature of the inner rod 11.

What is claimed is:

1. A telescopic hand tool, comprising a telescopic rod, one end of the telescopic rod being provided with a working head, another end of the telescopic rod being provided with a grip;
the telescopic rod including an inner rod and an outer tube slidably fitted on the inner rod, a circumferential side wall of the inner rod being formed with at least one rack gear along an axis, a circumferential side wall of the outer tube being formed with a positioning hole corresponding to the at least one rack gear;
a positioning member, accommodated in the positioning hole, the positioning member having a reciprocating movement along a central axis of the positioning hole, the positioning member having at least one toothed portion corresponding to the at least one rack gear, the at least one toothed portion having at least two engaging teeth;
a control sleeve, slidably fitted on the outer tube at a position surrounding the positioning member, wherein the control sleeve is slidable along the outer tube to form a locking position and an unlocking position; when in the locking position, the control sleeve presses the positioning member to make the toothed portion engaged with the at least one rack gear; when in the unlocking position, the control sleeve releases the positioning member to make the toothed portion disengaged from the at least one rack gear.

2. The telescopic hand tool as claimed in claim 1, wherein the circumferential side wall of the inner rod is formed with a guide groove extending along the axis, the positioning member has a guide slider corresponding to the guide groove, and the guide slider is slidable in the guide groove.

3. The telescopic hand tool as claimed in claim 2, wherein either side of the guide groove of the inner rod is provided with the rack gear, either side of the guide slider of the positioning member is provided with the toothed portion, when the control sleeve is in the locking position, each toothed portion is engaged with the corresponding rack gear.

4. The telescopic hand tool as claimed in claim 1, wherein the positioning member has a base, one side of the base, facing the working head, has a first restricting edge, another side of the base, facing the grip, has a second restricting edge, when the control sleeve is either in the locking position or in the unlocking position, the first restricting edge and the second restricting edge are continuously restricted by an inner peripheral wall of the positioning hole to make a bearing portion of the positioning member continuously face toward an inner wall of the control sleeve, and to make the toothed portion continuously face the at least one rack gear.

5. The telescopic hand tool as claimed in claim 1, wherein the positioning member has a base, the base corresponds in shape to the positioning hole, the base is slightly smaller than the positioning hole so that a gap is defined between the base and an inner peripheral wall of the positioning hole, and the positioning member has a translational movement relative to the outer tube.

6. The telescopic hand tool as claimed in claim 1, wherein the positioning member has a base, the base has a first side surface facing the inner rod and a second side surface opposite to the first side surface, the first side surface has the at least one toothed portion, the second side surface has a bearing portion, an inner wall of the control sleeve has a reduced portion and an enlarged portion adjacent to the reduced portion, an inner diameter of the enlarged portion is greater than an inner diameter of the reduced portion, when the control sleeve is in the locking position, the bearing portion is restricted in the reduced portion, when the control sleeve is in the unlocking position, the bearing portion is in the enlarged portion of the control sleeve, so that the positioning member has the reciprocating movement along the central axis of the positioning hole.

7. The telescopic hand tool as claimed in claim 6, wherein the control sleeve has a first end and a second end opposite to the first end, the reduced portion is disposed at the second end, the inner diameter of the reduced portion is greater than an outer diameter of the outer tube so that an annular space is formed between the reduced portion and the outer tube, the telescopic hand tool further comprises a restricting ring, the restricting ring is located at the second end of the control sleeve, the restricting ring has at least one blocking wall corresponding to the annular space, and the blocking wall is inserted in the annular space.

8. The telescopic hand tool as claimed in claim 7, wherein the reduced portion has a mating groove, the blocking wall has a mating block corresponding to the mating groove, and the mating block is mated with the mating groove to secure the restricting ring to the second end of the control sleeve.

9. The telescopic hand tool as claimed in claim 1, further comprising an elastic member for providing an elastic force to push the control sleeve so that the control sleeve has a tendency moving toward the locking position.
